(19) United States
(12) Patent Application Publication
(10) Pub. No.: US 2007/0162468 A1
(43) Pub. Date: Jul. 12, 2007

(54) Localization layer and method for delivery of change packages

(76) Inventors: Ralf Dentzer, Hockenheim (DE); Udo Klein, Maximiliansau (DE); Gernot Krause, Sandhausen (DE); Gisella Dominguez Anzuinelli, Heidelberg (DE)

Correspondence Address: SCHWEGMAN, LUNDBERG, WOESSNER & KLUTH, P.A., P.O. BOX 2938, MINNEAPOLIS, MN, 55402, US

(21) Appl. No.: 11/322,690

(22) Filed: Dec. 30, 2005

(51) Int. Cl. G06F 7/00

(52) U.S. Cl. 707/100

(57) ABSTRACT

A system including a local geopolitical business object associated with a geographical location that includes information and processes associated with a geographical location. The system includes a global business object that includes information and processes associated with a plurality of geographical locations. The system also includes a link between the local geopolitical object and the global business object.

### BACKGROUND

Many aspects of human capital management can be computerized to aid both the employees and management carry out tasks in organizations. Over time, some aspects of human capital management change. The changes may occur at different times and for different reasons. In some areas of human capital management, the changes occur with higher frequency than with other areas. One example of an area that changes with relatively high frequency are the laws related to human capital management associated with various countries. Many times a legal change in a country will require a change to the entire instruction set associated with the computerized human capital management task. The changes are generally effectuated by implementing a change in the entire instruction set associated with one or more human capital management tasks. These changes are generally referred to as a patch. Each time a legal patch is made, errors can occur in the instructions associated with a human capital management task. For example, when a software developer changes the instruction set or develops a patch to implement new laws for overtime pay in Germany, the developer may also inadvertently also change the instruction set for overtime pay in China. Patches on a large instruction set may be slow and prone to error. The chance of error is further exacerbated when legal changes for several countries are implemented in one patch. Many countries have laws that take effect on the first of the year. A patch that incorporates changes to an instruction set associated with a task would be prone to error and would take a long time to implement.

### BRIEF DESCRIPTION OF THE DRAWINGS

FIG. 1 is a block diagram of a computing environment, according to an example embodiment.

FIG. 2 is a display of a model of a business object, according to an example embodiment.

FIG. 3 is a schematic of a plurality of local geopolitical business objects and a global business object, according to an example embodiment.

FIG. 4 is a schematic of a system including a local geopolitical business object that includes an interface to the global business object, according to an example embodiment.

FIG. 5 is a flow diagram of a method for the local geopolitical business object to interface with the global business object, according to an example embodiment.

FIG. 6 is a schematic of a system including local geopolitical nodes extending a global business object, called extension nodes, according to an example embodiment.

FIG. 7 is a schematic of a system including a first global business object with local geopolitical extension nodes, a local geopolitical business object that includes an interface to a second global business object, according to an example embodiment.

FIG. 8 is a block diagram of a computer system that executes programming, according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software or a combination of software and human implemented procedures in one embodiment. The software comprises computer executable instructions stored on computer readable media such as memory or other type of storage devices. The term “computer readable media” is also used to represent carrier waves on which the software is transmitted. Further, such functions correspond to modules, which are software, hardware, firmware or any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

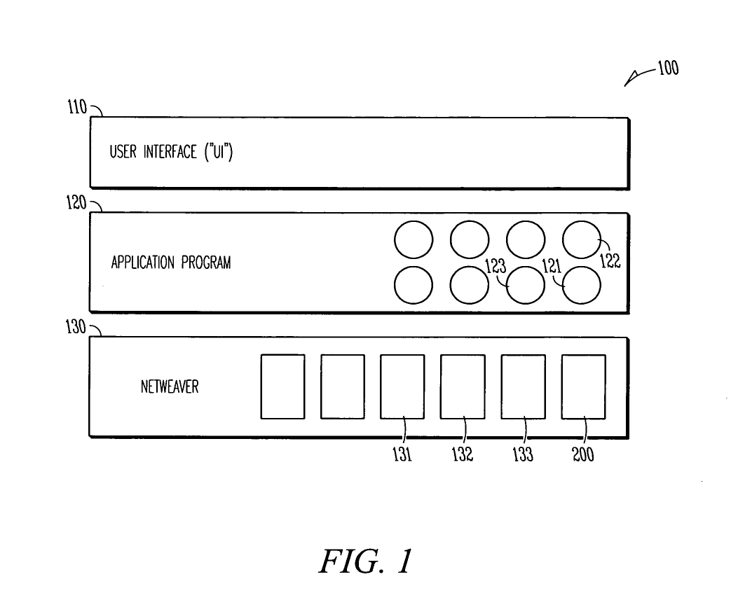

FIG. 1 is a block diagram of a computing system 100, according to an example embodiment. The computing environment 100 includes a user interface 110, an application program level 120 and a comprehensive integration and application platform layer 130. The comprehensive integration and application platform layer works with an existing infrastructure to enable and manage change. The comprehensive integration and application platform 130 includes a plurality of business applications, known as business components, which reduce the need for custom integration. The comprehensive integration and application platform includes a business component 131, 132, and 133. The comprehensive integration and application platform 130 also includes a business component 200, which includes various integration tools for performing business analysis on business information within the computing environment 100. The application program layer 120 also includes a number of distributed objects 121, 122, 123. The object is a technical representation of a concept that includes data and logic. In one example embodiment, the object, such as object 131, 132, 133 is referred to as a business object and is a technical representation of a business concept that includes data and logic.

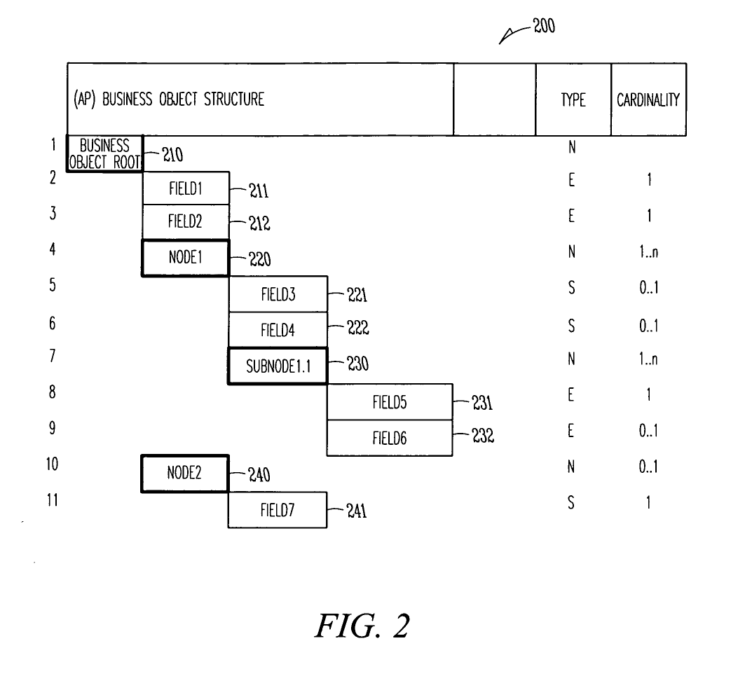

FIG. 2 is a display of a model 200 of a business object, such as business object 121, according to an example embodiment. A business object or object has a structure that includes a root 210, nodes such as nodes 220 and 240, and a sub node 230. Associated with a business or a root 210 is a grouping of information related to the business object root or root 210. Some of the information is held in fields such as 211 and 212. The information is also held in a node 220 which in turn also represents a grouping of information such as data and logic which are held in fields 221 and 222. Also under the root 210 and node 220 is a sub node 230. Sub node 230 holds another grouping of information that includes data and logic that are held in fields 231, 232. The business object 200 also includes another node 240. Node 240 is at the same level as node 220 and includes another grouping of data and logic which includes field 241. Therefore, it is seen that object 200 or business object 200 has a structure which includes a root 210, nodes, such as nodes 230 and 240, and sub nodes, such as sub node 230. It should be noted that FIG. 2 shows a simplified example of the structure of an object or business object 200. In actuality, a business object or object 200 may have a more complex structure. However, the principles as set forth in FIG. 2 will be followed where each root, node and/or sub node includes a grouping of information that can include data and logic.

In some embodiments, the structure of the business object or an outline of the business object is used to form a model of the business object 200. A model is useful for the purposes of designing and programming in a business object, such as business object 200. A model of the business object 200 shows the structure. In some embodiments, the model is referred to as a template. A template or model can take on any form just so it shows the structure of the object or business object 200. As shown in FIG. 2, the template is formed on a spreadsheet, such as an Excel spreadsheet. Excel is a registered trademark of Microsoft Corporation.

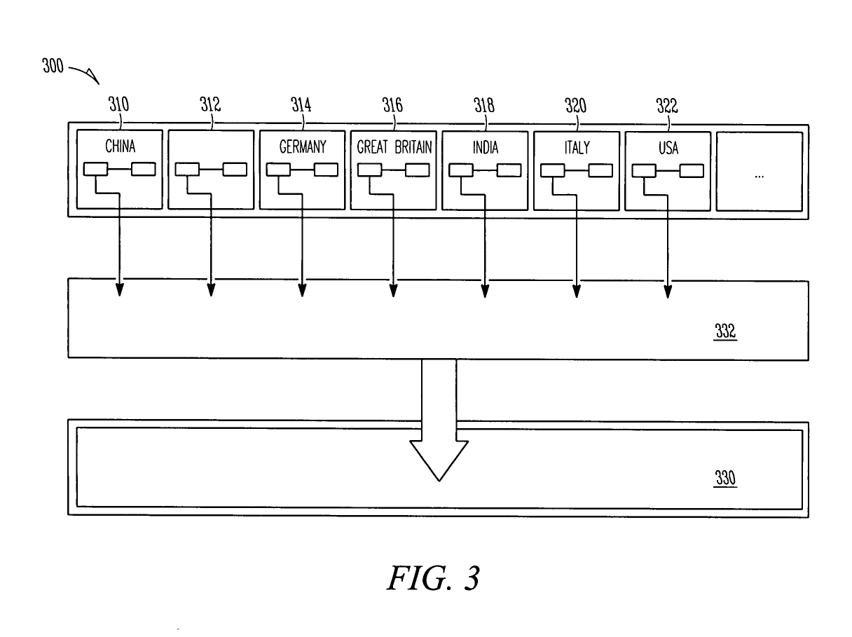

FIG. 3 is a schematic of a system 300 that includes plurality of local geopolitical business objects 310, 312, 314, 316, 318, 320, 322, and a global business object 310, according to an example embodiment. The local geopolitical business objects 310, 312, 314, 316, 318, 320, 322 include data and processes or subsystems that are specific to the geography associated with the geopolitical object. As shown in FIG. 3, the local geopolitical business objects 310, 312, 314, 316, 318, 320, 322 relate to different countries. In other embodiments, the local geopolitical business objects 310, 312, 314, 316, 318, 320, 322 could relate to portions of countries or even different regions around the world. For example, one example of a local geopolitical business objects might be for a region such as the European Union. In the European Union, some processes might be uniform across the European Union. Generally, the processes and data associated with one of the local geopolitical business objects, such as the local geopolitical business object 310 related to China, will differ from the processes and data associated with another of the local geopolitical business objects, such as the local geopolitical business object 312 related to France. The global business object 330 will include processes and data that apply to many of the geographies associated with the local geopolitical business objects 310, 312, 314, 316, 318, 320, 322. It should be noted that the global business object 330 need not include processes and data that apply worldwide, but merely needs to include process and data that apply to more than one geography associated with the plurality of local geopolitical business objects 310, 312, 314, 316, 318, 320, 322. In some embodiments, the global business object 330 includes processes and data independent of a geographical area. In still other embodiments, there are a plurality of global business objects that are referred to as a core layer of global business objects.

Each of the local geopolitical business objects 310, 312, 314, 316, 318, 320, 322 includes a link or interface to the global business object 330. Each of the local geopolitical business objects 310, 312, 314, 316, 318, 320, 322 includes both a link to the global business object 330 and processes and data which are unique to the particular local geopolitical business objects. The global business object 330 has an interface or link 332 that is used by each of the local geopolitical business objects 310, 312, 314, 316, 318, 320, 322.

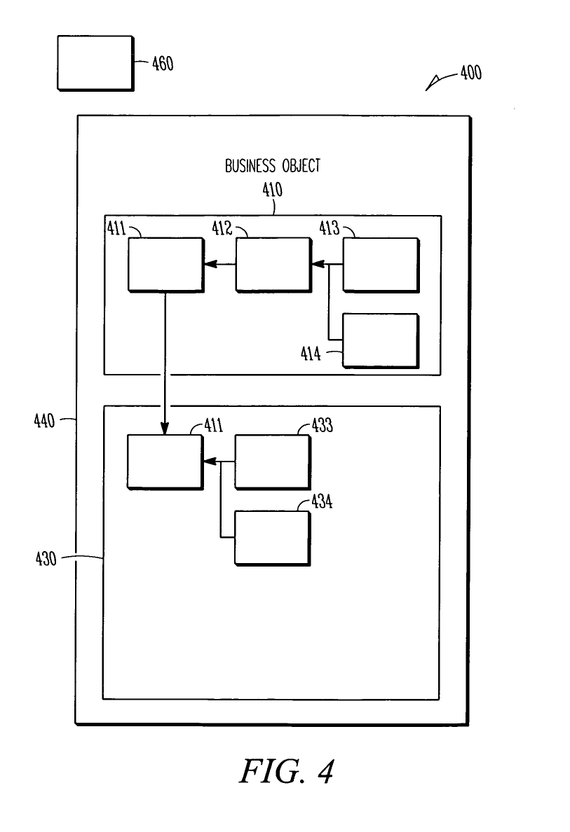

FIG. 4 is a schematic of a system 400 including a local geopolitical business object 410 that includes an interface 440 to the global business object 430, according to an example embodiment. The system 400 includes a local geopolitical business object 410 associated with a geographical location that includes a root node 411, a subnode 412, and information and processes 413, 414 associated with a geographical location. The system 400 includes a global business object 430 that includes a root node 431, and information and processes 433, 434 associated with a plurality of geographical locations. The system 400 also includes a link 440 between the local geopolitical object 410 and the global business object 430. The system 400 also includes an editor 460 to implement changes to the local geopolitical business object 410. In one embodiment, the editor 460 is used to implement legal changes in the local geopolitical business object 410 in response to a legal change within a geographical location. The local geopolitical business object 410 includes a first process module 413 that determines a first component related to the local geopolitical business object 410, and the global business object 430 comprises a second process module 433 that determines a second component related to the first component. In some embodiments, an arithmetic unit uses the first component to determine the second component.

The system 400 can include a plurality of local geopolitical business objects, such as local geopolitical business object 410. Then the system 400 includes a global business object 430, and one or more local geopolitical business objects 410 including local geopolitical processes and data. In the system having a plurality of local geopolitical business objects, each of the local geopolitical business objects 410 have a common interface across all of the one or more local geopolitical business objects 410 to interface with the global business object 430. The global business object 430 also includes processes and data independent of a geographical area. The local geopolitical business object 430 includes legal processes and data related to the legal processes. In another embodiment, the local geopolitical business object includes tax processes and data related to the tax processes.

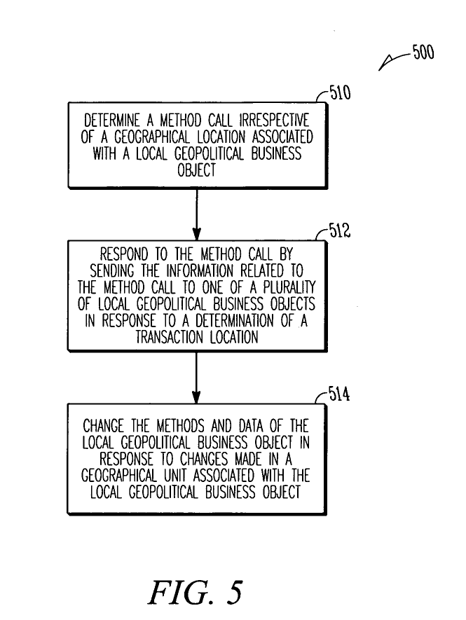

FIG. 5 is a flow diagram of a method 500 for the local geopolitical business object to interface with the global business object, according to an example embodiment. The method 500 includes determining a method call irrespective of a geographical location associated with a local geopolitical business object 510, and responding to the method call by sending the information related to the method call to one of a plurality of local geopolitical business objects in response to a determination of a transaction location 512. The local geopolitical business object includes methods and data. In some embodiments, the method 500 also includes changing the methods and data of the local geopolitical business object in response to changes made in a geographical unit associated with the local geopolitical business object 514. In some embodiments, the geographical unit is a portion of a country while in other embodiments, the geographical unit is a country. In some embodiments, changing the methods and the data of the local geopolitical business object is done in response to legislative changes made in a geographical unit associated with the local geopolitical business object.

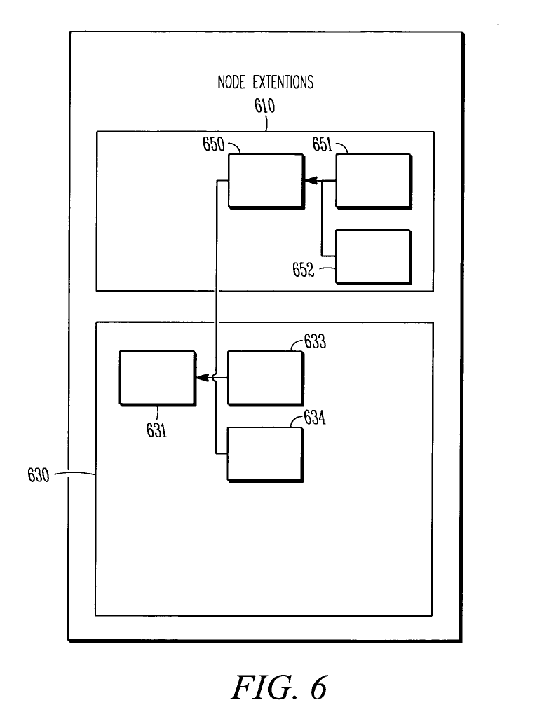

FIG. 6 is a schematic of a system 600 including a local geopolitical business object 610 and a global business object 630. The local geopolitical business object 610 includes local geopolitical nodes 650, 651, 652 that extend the global business object 630. The local geopolitical nodes 650, 651, 652, in some embodiments, are called extension nodes. The global business object 630 includes a root node 631, and information and processes 633, 634 associated with a plurality of geographical locations. The local geopolitical business object 610 includes a node extension 650 from the node 634 in the global business object 630. The local geopolitical business object includes a first extension node 651 and a second extension node 652 that includes data and information related to the geography associated with the local geopolitical business object 610. In some embodiments, the extension nodes 651, 652 include information and processes associated with a geographical location. In some embodiments the extension nodess include legal information specific to a geography associated with the local geopolitical business object 610. In some embodiments, the information and processes 633, 634 associated with the global business object 630 relate to common requirements for a plurality of geographical locations.

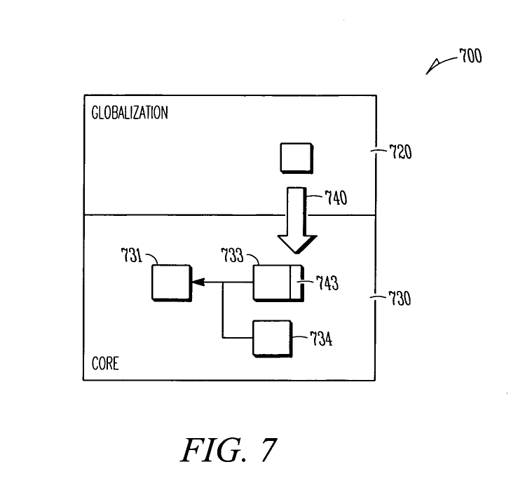

FIG. 7 is a schematic of a system 700 including a global business object 730 that includes a root node 731, and a first subnode 733, and a second subnode 734, according to an example embodiment. The subnodes 733 and 734 include information and processes associated with a plurality of geographical locations. The subnode 733 includes a field extension 743 that includes local information specific to a selected geographic location. The field extension 743 supplements semantics existing in the root node 731 and specifically in the first subnode 733. In some example embodiments, the field extensions 743 are referred to as country fields as the field extension 743 includes country specific information. The field extensions 743 is a placeholder in the global business object 730 for extension fields in at least one local geopolitical business object 720 a localization layer. In some embodiments, several local geopolitical business objects 720 may be used to store one or a few country fields or field extensions. In other example embodiments, a field extension or country field 743 is used when the information in the field extension 743 is predicted to change infrequently. The local geopolitical business object 720, in some embodiments, controls the information and process in the field extension 743. The system 700 includes a link 740 between the local geopolitical object 720 and the global business object 730. The link 740 is the assignment of the fields in the local geopolitical business object 720 to the global business object subnode 733 via the placeholder 743, thus establishing the field extension.

A system includes a core layer including at least one global business object that includes information and processes associated with a plurality of geographical locations, and a localization layer including local geopolitical data structures associated with geographical locations that include information and processes associated with a geographical location. The system also includes a link between local geopolitical data structures and a global business object. In one embodiment, the local geopolitical data structure is a business object. In another embodiment, the local geopolitical data structure is a node. In still another embodiment, the local geopolitical data structure is a field. In a yet another embodiment, the local geopolitical data structure is a combination of one or more business objects, nodes, and fields.

In operation, the local geopolitical business objects include information and processes that need patches or are changed with higher frequency than the global business objects. It has been found that legal changes occur with higher frequency than other processes. If a legal processes are placed in the local geopolitical business objects then the global business object is not subject to change as often. The local geopolitical business objects can be changed without affecting other local geopolitical business objects. An extensive process which is subject to legal changes is placed in a local geopolitical business object. A less extensive process subject to legal changes is placed in local geopolitical business object as a field extension to a field in the global business object.

Use of local geopolitical business objects in combination with global business objects is widely applicable. One area is where legal changes occur since legal changes occur with higher frequency than other underlying changes. An example of such an area is in Human Resources Management, and specifically in hiring and paying of personnel. Almost all geographic areas have different laws that apply to employees and many have different reporting requirements. For example, the laws of Germany differ from the laws of the United States. Taxes are different in these different geographical areas. In the United States, the various states also differ from one another since each may have different income tax rates or no income taxes at all. All the information related to an employee and his working relationship with the company are recorded. This information can be placed in a global business object. This information will not change often. The employee will generally be paid at a selected rate. The employee may have a yearly salary and can be paid monthly, bimonthly, weekly, every two weeks, or the like. The global business object will include a process that determines the pay for a selected pay period. This amount will be used by a local geopolitical business object which includes tax rates for income taxes, social taxes, and other taxes. The local geopolitical business object can use the base pay to determine the tax owed by the individual employee. This amount may be withheld by the employee in a paycheck. The process of figuring out the taxes can be housed in the local geopolitical business object as a separate process. In another embodiment, the basic process may be located in the global business object and the tax rates associated with a specific geography may be held as a field extension in a local geopolitical business object. Of course, this is just one example application and many more exist, such as for generating reports for different governmental bodies associated with different geographical areas.

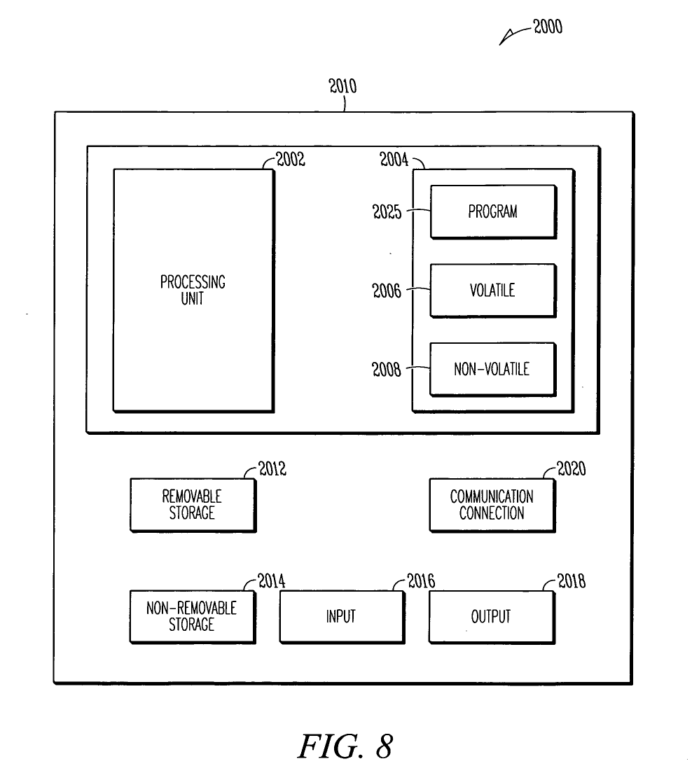

A block diagram of a computer system 2000 that executes programming for performing the above algorithm is shown in FIG. 8, according to an example embodiment. A general computing device in the form of a computer 2010, may include a processing unit 2002, memory 2004, removable storage 2012, and non-removable storage 2014. Memory 2004 may include volatile memory 2006 and non-volatile memory 2008. Computer 2010 may include—or have access to a computing environment that includes—a variety of computer-readable media, such as volatile memory 2006 and non-volatile memory 2008, removable storage 2012 and non-removable storage 2014. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 2010 may include or have access to a computing environment that includes input 2016, output 2018, and a communication connection 2020. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 2002 of the computer 2010. A hard drive, CD-ROM, and RAM are some examples of articles including a computer-readable medium. For example, a computer program 2025 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer system 2000 to provide generic access controls in a COM based computer network system having multiple users and servers.

A machine-readable medium includes a set of instructions that, when executed by a machine, perform the method of determining a method call irrespective of a geographical location associated with a local geopolitical business object, and responding to the method call by sending the information related to the method call to one of a plurality of local geopolitical business objects in response to a determination of a transaction location.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A system comprising:
a local geopolitical business object associated with a geographical location that includes information and processes associated with a geographical location;
a global business object that includes information and processes associated with a plurality of geographical locations; and
a link between the local geopolitical object and the global business object.

2. The system of claim 1 further comprising an editor to implement changes to the local geopolitical business object.

3. The system of claim 1 further comprising an editor to implement legal changes in the local geopolitical business object in response to a legal change within a geographical location.

4. The system of claim 3 wherein the local geopolitical business object comprises a first process module that determines a first component related to the local geopolitical business object

5. The system of claim 1 wherein the local geopolitical business object comprises a first process module that determines a first component related to the local geopolitical business object; and
wherein the global business object comprises a second process module that determines a second component related to the first component.

6. The system of claim 5 further comprising an arithmetic unit that uses the first component in determining the second component.

7. The system claim 1 wherein the global business object includes a node and a field, and wherein the local geopolitical business object includes a field extension of the field in the global business object.

8. The system claim 7 wherein the node and the field in the global business object is independent of geographical information, and wherein the field extension includes geographic specific information.

9. The system claim 7 wherein information and processes associated with a local geopolitical business object includes legal information.

10. The system claim 1 wherein the information and processes associated with the global business object relates to common requirements for a plurality of geographical locations.

11. A system comprising:
a global business object; and
one or more local geopolitical business objects including local geopolitical processes and data and a common interface across all of the one or more local geopolitical business objects to interface with the global business object.

12. The system of claim 10 wherein the global business object further comprises processes and data independent of a geographical area.

13. The system of claim 10 wherein the local geopolitical business object includes legal processes and data related to the legal processes.

14. The system of claim 10 wherein the local geopolitical business object includes tax processes and data related to the tax processes.

15. A method comprising:
determining a method call irrespective of a geographical location associated with a local geopolitical business object; and
responding to the method call by sending the information related to the method call to one of a plurality of local geopolitical business objects in response to a determination of a transaction location.

16. The method of claim 15 wherein the local geopolitical business object includes methods and data, the method further comprising changing the methods and data of the local geopolitical business object in response to changes made in a geographical unit associated with the local geopolitical business object.

17. The method of claim 16 wherein the geographical unit is a portion of a country.

18. The method of claim 16 wherein the geographical unit is a country.

19. The method of claim 15 wherein the local geopolitical business object includes methods and data, the method further comprising changing the methods and data of the local geopolitical business object in response to legislative changes made in a geographical unit associated with the local geopolitical business object.

20. A system comprising:
a core layer including at lease one global business object that includes information and processes associated with a plurality of geographical locations;
a localization layer including local geopolitical data structures associated with geographical locations that include information and processes associated with a geographical location; and
a link between local geopolitical data structures and a global business object.

21. The system of claim 20 wherein the local geopolitical data structure is a business object.

22. The system of claim 20 wherein the local geopolitical data structure is a node.

23. The system of claim 20 wherein the local geopolitical data structure is a field.
